(19) United States
(12) Patent Application Publication
(10) Pub. No.: US 2005/0288169 A1
(43) Pub. Date: Dec. 29, 2005

(54) Protective layer of gas discharge display device and method of forming the same

(76) Inventors: Min-Suk Lee, Suwon-si (KR); Jong-Seo Choi, Suwon-si (KR); Min-Ho Oh, Suwon-si (KR); Jae-Hyuk Kim, Suwon-si (KR); Soon-Sung Suh, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/165,449

(22) Filed: Jun. 23, 2005

(30) Foreign Application Priority Data
Jun. 26, 2004 (KR) 10-2004-0048655

(51) Int. Cl. H01B 3/10; B05D 5/12

(52) U.S. Cl. 501/108; 427/126.1; 427/126.3

(57) ABSTRACT

Provided is a protective layer formed using at least one selected from the group consisting of a magnesium oxide and a magnesium salt and at least one selected from the group consisting of a lithium salt, a lithium oxide, a germanium oxide, and a germanium element. Provided is also a composition for forming a protective layer. When the composition is used for a protective layer of a gas discharge display device, an electrode or a dielectric can be protected from plasma ions generated by discharge of a mixed gas of Ne+Xe or He+Ne+Xe, a lower discharge voltage and a shorter discharge lag time can be obtained.

### CROSS-REFERENCE TO RELATED APPLICATIONS

This application claims the priority of Korean Patent Application No. 10-2004-0048655, filed on Jun. 26, 2004, in the Korean Intellectual Property Office, the disclosure of which is incorporated herein in its entirety by reference.

### FIELD OF THE INVENTION

The present invention relates to a protective layer of a gas discharge display, and more particularly, to a dielectric protective layer which has excellent discharge characteristics and a method of forming the same.

### DESCRIPTION OF THE RELATED ART

Plasma display panels (PDPs) are self-emission devices that can be easily manufactured as large displays, and have good display quality and rapid response speed. In particular, because of their thinness, PDPs have received much interest as wall-hanging displays, like liquid crystal displays (LCDs).

FIG. 1 illustrates a PDP pixel. Referring to FIG. 1, discharge sustain electrodes (15 for each), each including a pair of a first electrode and a second electrode, are formed on a lower surface of a front glass substrate 14. The discharge sustain electrodes are covered with a dielectric layer 16 made of glass. The dielectric layer 16 is covered with a protective layer 17 to prevent a reduction in discharge and lifetime characteristics due to direct exposure of the dielectric layer 16 to a discharge space.

Generally, a protective layer prevents an upper dielectric layer from colliding with gaseous ions upon plasma discharge, and at the same time, emits secondary electrons. Thus, the protective layer must satisfy the requirements of insulating property, sputtering resistance, low discharge voltage, rapid discharge response, visible light transmission, etc.

Meanwhile, a patterned ITO electrode is formed on a front glass substrate, a bus electrode is formed on the ITO electrode, and a dielectric layer covers the ITO electrode and the bus electrode by a printing method. The front glass substrate is separated from a rear glass substrate by several tens of μm. A space defined between the front glass substrate and the rear glass substrate is filled with an ultraviolet (UV)-emitting Ne+Xe mixed gas or He+Ne+Xe mixed gas under a predetermined pressure, for example 450 Torr.

An Xe gas emits vacuum UV (VUV) (Xe ions emit resonance radiation at 147 nm and Xe₂ emits resonance radiation at about 173 nm). A Ne gas and a Ne+He mixed gas lower the discharge initiation voltage.

Korean Patent Laid-Open Publication No. 2001-48563 discloses a protective layer of a PDP, coated with trace amount of a dopant, having an increased secondary electron emission coefficient in a discharge gas, i.e., Xe gas. According to the patent publication, the use of the Xe gas alone enables high-density VUV radiation and thus conversion efficiency into visible light can be elevated to the quantum efficiency of phosphors. However, this technique is impractical in display devices due to very high discharge initiation voltage.

In view of the above problems, to lower a discharge initiation voltage which increases with an increase in the amount of an Xe gas for high brightness discharge, attempts to incorporate a He gas into a Ne+Xe mixed gas has been made. The use of a He gas is advantageous in lowering a discharge initiation voltage due to the high mobility of He ions but may cause severe sputtering etching of a protective layer and phosphors.

### SUMMARY OF THE INVENTION

The present invention provides a protective layer which reduces an increase in discharge voltage due to the use of an increased amount of a Xe gas for high brightness, and at the same time, provides a shorter discharge lag time for single scan. The present invention also provides a composition for forming the protective layer, a method of forming the protective layer, and a plasma display panel (PDP) including the protective layer.

According to an aspect of the present invention, there is provided a protective layer formed using a composition with at least one selected from the group consisting of a magnesium oxide and a magnesium salt and at least one selected from the group consisting of a lithium salt, lithium oxide, germanium oxide, and a germanium element.

The magnesium salt may be MgCO₃ or Mg(OH)₂.

The lithium salt may be selected from the group consisting of Li₂CO₃, LiCl, LiNO₃, and Li₂SO₄.

The germanium element may be an ultrafine germanium particle.

The amount of each of the lithium salt and the lithium oxide may be in the range from about 0.02 to about 2 mole% based on produced magnesium oxide.

The amount of the germanium oxide may be in the range from about 0.02 to about 2 mole % based on produced magnesium oxide.

According to another aspect of the present invention, there is provided a composition for forming a protective layer including at least one selected from the group consisting of a magnesium oxide and a magnesium salt and at least one selected from the group consisting of a lithium salt, lithium oxide, germanium oxide, and a germanium element.

The amount of each of the lithium salt and the lithium oxide may be in the range from about 0.02 to about 2 mole % based on produced magnesium oxide.

The amount of the germanium oxide may be in the range from about 0.02 to about 2 mole % based on produced magnesium oxide.

According to still another aspect of the present invention, there is provided a method of forming a protective layer, the method including: (a) uniformly mixing at least selected from the group consisting of a magnesium oxide and a magnesium salt and at least one selected from the group consisting of a lithium salt, a lithium oxide, a germanium oxide, and a germanium element in the presence of a flux to obtain a mixture; (b) thermally treating the mixture; and (c) forming a deposition film using the thermally treated mixture.

In step (a), the flux may be MgF₂ or LiF.

Step (b) may include calcining the mixture of (a) and pelletizing the calcined mixture to sinter the resultant pellets.

The calcining may be performed at about 400 to about 800° C. and the sintering may be performed at about 800 to about 1,600° C.

Operation (c) may be performed by chemical vapor deposition (CVD), e-beam, ion-plating, or sputtering.

According to yet another aspect of the present invention, there is provided a plasma display panel including: a transparent front substrate; a rear substrate disposed in parallel to the front substrate; barrier ribs arranged between the front substrate and the rear substrate to define discharge cells; address electrodes arranged along the discharge cells arranged in a direction of the rear substrate and covered with a rear dielectric layer; a phosphor layer disposed in the discharge cells; sustain electrode pairs extended to intersect with the address electrodes and covered with a front dielectric layer; a protective layer formed on a lower surface of the front dielectric layer using at least one selected from the group consisting of a magnesium oxide, a lithium salt, a lithium oxide, and a germanium oxide; and a discharge gas within the discharge cells.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating an example of one pixel of a plasma display panel (PDP);

FIG. 2 is a graph illustrating the temperature dependency of a discharge lag time;

FIG. 3 is a view illustrating the Auger neutralization theory describing electron emission from a solid surface by a gas ion; and

FIG. 4 illustrates a PDP including a protective layer according to an embodiment of the present invention.

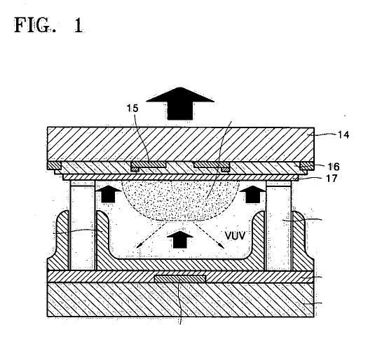

### DETAILED DESCRIPTION OF THE INVENTION

The present invention will now be described more fully with reference to the accompanying drawings, in which exemplary embodiments of the invention are shown.

Generally, a protective layer of a plasma display panel (PDP) performs the following three functions.

First, a protective layer protects an electrode and a dielectric layer. Discharging can occur even when only an electrode or only an electrode and a dielectric layer are used. However, when only an electrode is used, it may be difficult to control a discharge current. On the other hand, when only an electrode and a dielectric layer are used, damage to the dielectric layer by sputtering may occur. Thus, the dielectric layer must be coated with a protective layer resistant to plasma ions.

Second, a protective layer lowers a discharge initiation voltage. A discharge initiation voltage is directly correlated with the coefficient of secondary electron emission from a material constituting the protective layer by plasma ions. A secondary electron emission coefficient is inversely proportional to a discharge initiation voltage. That is, as the amount of secondary electrons emitted from the protective layer increases, the discharge initiation voltage decreases. Low secondary electron emission coefficient of a dielectric must be compensated by high secondary electron emission coefficient of a protective layer.

Finally, a protective layer reduces a discharge lag time. The discharge lag time refers to the length of time of the phenomenon in which discharging occurs at a predetermined time after a voltage is applied, and can be represented by the sum of two components: formation lag time (Tf) and statistical lag time (Ts). The formation lag time is the time between when a voltage is applied and when a discharge current is induced, and the statistical lag time is a statistical dispersion of the formation lag time. The lower the discharge lag time, the faster addressing for single scan can be done, thereby reducing scan drive costs. Further, a lower discharge lag time can increase the number of sub-fields and thus improve brightness and image quality.

When a voltage is applied between bus electrodes and address electrodes, seed electrons generated by cosmic ray or LV ray collide with a discharge gas to generate discharge gas ions. Collision of the discharge gas ions with a protective layer ejects large amounts of secondary electrons from the protective layer, thereby leading to discharge in discharge cells.

According to the Auger neutralization theory, when gas ions collide with a solid, electrons from the solid travel to the gas ions to thereby create a neutral gas. At this time, holes are formed in the solid with ejection of other electrons of the solid into vacuum. The secondary electron emission coefficient of a solid material can be represented by Equation 1 below:
Eₖ=E_{I}−2(E_{g}+χ), (1)
where Eₖ is an energy for ejections of electrons of a solid into vacuum, E_{I} is a gas ionization energy, E_{g} is the bandgap energy of the solid, and χ is electron affinity. Table 1 presents resonance emission wavelengths and ionization voltages of inert gases. To increase the optical conversion efficiency of phosphors, it is preferable to use a Xe gas emitting VUV with the longest wavelength.

However, the Xe gas exhibits a very high discharge voltage due to low ionization voltage because when the bandgap energy (E_{g}) of a solid material constituting a protective layer and the electron affinity (χ) are about 7.7 eV and about 0.5, respectively, the energy for electron emission from the protective layer, Eₖ is less than about 0. In this regard, to decrease a discharge voltage, the use of a gas with a high ionization voltage is required. According to Equation 1, Eₖ is 8.19 eV for He and 5.17 eV for Ne. Since the Eₖ of He is higher than that of Ne, He can be discharged at a lower voltage. However, the use of a He gas in a PDP discharge may cause severe plasma etching of a protective layer due to the high mobility of He.

Thus, a Ne+Xe mixed gas is generally used in currently available PDPs. The amount of Xe is generally about 5 wt % but is being used in increasing amounts. An increase in Xe amount can increase brightness but causes the problem of increased discharge voltage.

TABLE 1
inert gases and ionization energies

| | Resonance-level | | | Metastable level | | Ioniza- |
|---|---|---|---|---|---|---|
| | excitation | | | excitation | | tion |
| | Voltage | Wavelength | Lifetime | Voltage | Lifetime | voltage |
| Gas | (V) | (nm) | (ns) | (V) | (ns) | (V) |
| He | 21.2 | 58.4 | 0.555 | 19.8 | 7.9 | 24.59 |
| Ne | 16.54 | 74.4 | 20.7 | 16.62 | 20 | 21.57 |
| Ar | 11.61 | 107 | 10.2 | 11.53 | 60 | 15.76 |
| Kr | 9.98 | 124 | 4.38 | 9.82 | 85 | 14.0 |
| Xe | 8.45 | 147 | 3.79 | 8.28 | 150 | 12.13 |

A protective layer of a PDP is generally made of monocrystalline MgO. Monocrystalline MgO that can be used in the formation of a protective layer is derived from a high-purity MgO sintered body. The MgO sintered body is grown to about 2 to about 3-inch particles in an arc furnace and then processed into pellets with a size of about 3 to about 5 mm to be used in the formation of a protective layer. A film formed using monocrystalline MgO as a deposition source is a polycrystalline film.

Table 2 presents the types and amounts of impurities that may be commonly contained in monocrystalline MgO. Forming a protective layer made of monocrystalline MgO is difficult with respect to controlling the type and amount of impurities. Generally, monocrystalline MgO contains a predetermined amount of impurities.

Examples of impurities that may be commonly contained in monocrystalline MgO include Al, Ca, Fe, Si, K, Na, Zr, Mn, Cr, Zn, B, and Ni. Most commonly, the impurities are Al, Ca, Fe, and Si. To improve the characteristics of a monocrystalline MgO film containing these impurities, the amount of the impurities may be controlled to a several hundred ppm level. In the present invention, these impurities may be contained in an amount of about 0.005 mole % or less based on produced MgO.

TABLE 2
ICP (Inductively Coupled Plasma) analysis results for monocrystalline MgO

| Impurity | Al | Ca | Fe | Si | K | Na | Zr | Mn | Cr | Zn | B | Ni |
|---|---|---|---|---|---|---|---|---|---|---|---|---|
| Amount | 80 | 220 | 70 | 100 | 50 | 50 | <10 | 10 | 10 | 10 | 20 | <10 |
| (ppm) | | | | | | | | | | | | |

FIG. 2 illustrates the temperature dependency of a discharge lag time.

In FIG. 2, Tf is a formation lag time and Ts is a statistical lag time. The formation lag time is the time between when a voltage is applied and when a discharge current is induced, and the statistical lag time is a statistical dispersion of the formation lag time.

As a discharge lag time decreases, high-speed addressing for single scan is possible. Therefore, scan drive costs can be reduced and the number of sub-fields can be increased, thereby increasing brightness and image quality. Furthermore, a shorter discharge lag time enables the realization of single scan of a high density (HD)-grade panel, and can increase brightness by increasing the number of sustain pulses and reduce a dynamic false contour by increasing the number of sub-fields constituting a television-field.

Referring to FIG. 2, monocrystalline MgO does not satisfy a discharge lag time necessary for single scan spec. On the other hand, with respect to polycrystalline MgO, discharging occurs more rapidly at high temperature and more slowly at low temperature. Such temperature dependency of a discharge lag time is attributed to impurities contained in MgO. A recent trend is that a protective layer of a PDP is formed using polycrystalline MgO. A manufacturing process of a protective layer made of polycrystalline MgO is easier to control regarding the amount of impurities present, relative to monocrystalline MgO. Also, since the deposition rate of polycrystalline MgO is faster than that of monocrystalline MgO, a shorter process duration can be obtained.

One embodiment of the present invention provides a protective layer formed using at least one selected from the group consisting of a magnesium oxide and a magnesium salt as a main component and a Li and/or Ge-containing material and a method of forming the same. The protective layer according to the present invention exhibits a better discharge initiation voltage and discharge lag time characteristics relative to conventional protective layers.

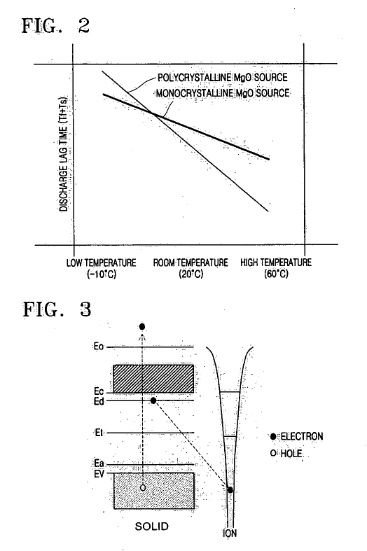

FIG. 3 illustrates electron emission from a solid surface by gas ions affecting the bandgap of MgO. MgO used for a protective layer of a PDP has a wide bandgap like diamond, and has a very low or negative electron affinity.

Doping of a protective layer with an impurity forms simultaneously a donor level (E_{d}), an acceptor level (Eₐ), and a deep level (Eₜ) between a valence band (Eᵥ) and a conduction band (E_{c}), thereby inducing a bandgap shrinkage effect. Since the effective bandgap energy (E_{g}) of MgO may be less than 7.7 eV according to Equation 1, Eₖ for Xe may be greater than 0.

MgO for forming a protective layer according to an embodiment is derived from at least one of magnesium oxide and a magnesium salt. The magnesium oxide may be MgO and the magnesium salt may be MgCO₃ or Mg(OH)₂.

To form various impurity levels, i.e., the donor level, the acceptor level, and the deep level between the valence band and the conduction band of MgO for band gap shrinkage effect, two different doping impurities may be used: Such impurities are an acceptor level-forming impurity and donor level-forming impurity.

The acceptor level-forming impurity and the donor level-forming impurity are impurities having an ion size about equal to or smaller than that of Mg²⁺. For example, the acceptor level-forming impurity may be a Li¹⁺ ion and the donor level-forming impurity may be a Ge⁴⁺ ion.

When a Li⁺ ion is substituted for a Mg²⁺ site, a hole may be formed in a valence level by formation of an acceptor level, or a donor level may be formed by induction of oxygen defect. Alternatively, the presence of a Li⁺ ion in a Mg lattice may form an acceptor level receiving electrons.

In one embodiment, a lithium component used as a lithium ion donor may be a lithium salt. Preferably, the lithium salt may be selected from Li₂CO₃, LiCl, LiNO₃, and Li₂SO₄. The amount of the lithium salt is in the range from about 0.02 to about 2 mole %, based on the amount of produced MgO. If the amount of the lithium salt is less than about 0.02 mole %, an addition effect may be insufficient. On the other hand, if it exceeds about 2 mole %, an insulating property may be lowered due to increased conductivity.

There may be used two types of Ge ions: Ge⁴⁺ and Ge²⁺. The Ge⁴⁺ ion forms a donor level of MgO, whereas the Ge²⁺ ion does not form an impurity level . However, electron hopping between Ge⁴⁺ and Ge²⁺ can increase electron mobility and facilitate electron transfer from bulk to surface of a protective layer.

In the forgoing embodiment, the germanium component used as a germanium ion donor may be germanium oxide or a germanium element. In one embodiment, the germanium oxide is GeO₂, and the germanium element is an ultrafine Ge particle.

The amount of the germanium component to be doped is in the range from about 0.02 to about 2 mole %, based on the amount of produced MgO. If the amount of the germanium component is less than about 0.02 mole %, an addition effect may be insufficient. On the other hand, if it exceeds about 2 mole %, an insulating property may be lowered due to increased conductivity.

Therefore, a protective layer according to one embodiment of the present invention is formed using at least one of magnesium oxide and a magnesium salt, and a lithium (Li) and/or germanium (Ge) component, and protects an electrode and a dielectric from plasma ions generated by discharge of a mixed gas such as Ne+Xe or He+Ne+Xe. Furthermore, the protective layer can rapidly emit a large amount of electrons, and exhibit little temperature dependency of a discharge lag time, and thus is suitable for an increase in Xe amount and a single scan.

Another aspect of the present invention provides a composition for forming a protective layer of a PDP, which includes: at least one of a magnesium oxide and a magnesium salt and at least one of a lithium salt, a lithium oxide, a germanium oxide, and a germanium element.

In one embodiment, each of the lithium salt and the lithium oxide is used in an amount of about 0.02 to about 2 mole % based on the amount of produced MgO. If the amount of each of the lithium salt and the lithium oxide is less than about 0.02 mole %, an addition effect may be insufficient. On the other hand, if it exceeds about 2 mole %, an insulating property may be lowered due to increased conductivity.

The germanium oxide is used in an amount of about 0.02 to about 2 mole % based on the amount of produced MgO. If the amount of the germanium oxide is less than about 0.02 mole %, an addition effect may be insufficient. On the other hand, if it exceeds about 2 mole %, an insulating property may be lowered due to increased conductivity.

Another aspect of the present invention provides a method of forming a protective layer, which includes: (a) uniformly mixing at least one of a magnesium oxide and a magnesium salt and at least one of a lithium salt, a lithium oxide, a germanium oxide, and a germanium element in the presence of a flux to obtain a mixture; (b) thermally treating the mixture; and (c) forming a deposition film using the thermally treated mixture.

In step (a), the flux may be, for example, MgF₂ or LiF. Step (b) may include calcining the mixture of (a) and pelletizing the calcined mixture to sinter the pelletized product.

The calcining may be performed at about 400 to about 800° C. for about 10 hours or less to facilitate aggregation between magnesium oxide and a dopant.

The calcining may not occur at less than about 400° C. On the other hand, the calcining may excessively occur at above about 800° C.

The sintering may be performed at about 800 to about 1,600° C. for about 3 hours or less to facilitate the crystallization of a material constituting pellets. If the sintering is performed at less than about 800° C, crystallization may not occur. On the other hand, if it exceeds about 1,600° C., severe loss of a dopant may occur.

The thus-formed pellets can optimize the composition of polycrystalline MgO which is a final product and a thermal treatment condition, thereby optimizing the characteristics of a protective layer made of polycrystalline MgO.

Step (c) may be performed by chemical vapor deposition (CVD), e-beam, ion-plating, or sputtering to form a protective layer.

One embodiment of the present invention also provides a plasma display panel comprising a transparent front substrate; a rear substrate substantially disposed in parallel to the front substrate;barrier ribs arranged between the front substrate and the rear substrate to define discharge cells; address electrodes extended along the discharge cells; a phosphor layer disposed in each discharge cell; sustain electrode pairs extending in a direction which intersects with the address electrodes; a front dielectric layer covering the sustain electrode pairs; a protective layer formed on a surface of the front dielectric layer; and a discharge gas contained within the discharge cells; and wherein the protective layer comprises at least one selected from the group consisting of a magnesium oxide and a magnesium salt and at least one selected from a group consisting of a lithium salt, a lithium oxide, a germanium oxide, and a germanium element.

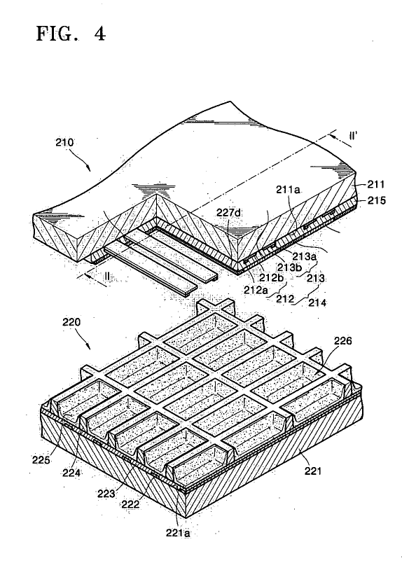

FIG. 4 illustrates a PDP. A front panel 210 includes a front substrate 211; sustain electrode pairs (214 for each) formed on a rear surface 211a of the front substrate 211, each sustain electrode pair 214 including a Y electrode 212 and an X electrode 213; a front dielectric layer 215 covering the sustain electrode pairs; and being formed using at least one selected from the group consisting of a magnesium oxide and a magnesium salt and at least one selected from a lithium salt, lithium oxide, germanium oxide, and a germanium element. The Y electrode 212 and the X electrode 213 include transparent electrodes 212b and 213b made of indium tin oxide (ITO), etc., and bus electrodes 212a and 213a made of a metal with good conductivity, respectively.

A rear panel 220 includes a rear substrate 221; address electrodes (222 for each) formed on a front surface 221a of the rear substrate 221 to intersect with the sustain electrode pairs; a rear dielectric layer 223 covering the address electrodes; a barrier rib 224 formed on the rear dielectric layer 223 to define discharge cells (226 for each); and a phosphor layer 225 disposed in the discharge cells.

A discharge gas within the discharge cells may be a mixed gas of Ne with at least one of Xe, N₂ and Kr₂, or a mixed gas of Ne with at least two of Xe, He, N₂, and Kr.

A protective layer according to an embodiment of the present invention can be used under a diatomic mixed gas of Ne+Xe which contains an increased amount of Xe for high brightness. A protective layer according to an embodiment of the present invention exhibits good sputtering resistance even in a triatomic mixed gas of Ne+Xe+He which contains a He gas for compensation for an increase in a discharge voltage, thereby preventing a reduction in the lifetime of a PDP. One embodiment of the present invention provides a protective layer capable of decreasing an increase in discharge voltage due to the use of an increased amount of Xe and satisfying a discharge lag time required for single scan.

### EXAMPLES

### Example 1

100 mole % of MgO, 2 mole % of Li₂CO₃, and 2 mole % of GeO₂ were placed in a mixer and uniformly mixed for 5 hours or more. The resultant mixture was placed in a crucible and heated in an electric furnace at 500° C. for 10 hours. The resultant product was compression-molded into pellets and sintered at 1,300° C. to prepare a deposition source.

Meanwhile, address electrodes made of copper were formed on a rear substrate with a thickness of 2 mm by photolithography. The address electrodes were covered with PbO glass to form a rear dielectric layer with a thickness of 20 μm. Then, the rear dielectric layer was coated with a BaAl₁₂O₁₉:Mn green-emitting phosphor.

Bus electrodes made of copper were formed on a front substrate with a thickness of 2 mm by photolithography. The bus electrodes were covered with PbO glass to form a front dielectric layer with a thickness of 20 μm. Then, the deposition source was deposited on the front substrate by e-beam evaporation to form a protective layer. At this time, the substrate temperature was 250° C., and the deposition pressure was adjusted to 1.5×10⁻⁴ torr by supply of oxygen and argon gases using a gas flow controller.

The front substrate and the rear substrate faced each other separated by a gap of 30 μm to define discharge cells. The discharge cells were filled with a mixed gas of 95% Ne and 5% Xe to thereby complete a PDP.

### Comparative Example 1

A PDP was manufactured in the same manner as in Example 1 except that a protective layer was formed using only MgO without a dopant.

### Comparative Example 2

A PDP was manufactured in the same manner as in Example 1 except that discharge cells were filled with a mixed gas of 90% Ne and 10% Xe.

### Comparative Example 3

A PDP was manufactured in the same manner as in Example 1 except that discharge cells were filled with a mixed gas of 80% Ne, 10% Xe, and 10% He.

A protective layer according to one embodiment of the present invention is suitable for an increase in Xe amount and a single scan, as compared to a protective layer made of only monocrystalline MgO. When the protective layer according to the present invention is used as a protective layer of a gas discharge display device, in particular a PDP, it can protect an electrode and a dielectric from plasma ions generated by discharge of a mixed gas of Ne+Xe or He+Ne+Xe. Furthermore, the protective layer according to one embodiment of the present invention can provide a lower discharge voltage and a shorter discharge lag time. In addition, the protective layer according to one embodiment of the present invention can prevent an increase in discharge voltage that may be caused by the use of an increased amount of Xe for high brightness and prevent a reduction in lifetime of a PDP that may be caused by addition of He gas.

1. A protective layer on a surface of a dielectric material comprising at least one selected from the group consisting of a magnesium oxide and a magnesium salt and at least one selected from a group consisting of a lithium salt, a lithium oxide, a germanium oxide, and a germanium element.

2. The protective layer of claim 1, wherein the magnesium salt is MgCO₃ or Mg(OH)₂.

3. The protective layer of claim 1, wherein the lithium salt is selected from the group consisting of Li₂CO₃, LiCl, LiNO₃, and Li₂SO₄.

4. The protective layer of claim 1, wherein the germanium element is an ultrafine germanium particle.

5. The protective layer of claim 1, wherein the amount of each of the lithium salt and the lithium oxide is in the range from about 0.02 to about 2 mole % based on produced magnesium oxide.

6. The protective layer of claim 1, wherein the amount of the germanium oxide is in the range from about 0.02 to about 2 mole % based on the amount of produced magnesium oxide.

7. A composition for forming a protective layer comprising at least one selected from the group consisting of a magnesium oxide and a magnesium salt and at least one selected from the group consisting of a lithium salt, a lithium oxide, a germanium oxide, and a germanium element.

8. The composition of claim 7, wherein the magnesium salt is MgCO₃ or Mg(OH)₂.

9. The composition of claim 7, wherein the lithium salt is selected from the group consisting of Li₂CO₃, LiCl, LiNO₃, and Li₂SO₄.

10. The composition of claim 7, wherein the germanium element is an ultrafine germanium particle.

11. The composition of claim 7, wherein the amount of the lithium oxide is in the range from about 0.02 to about 2 mole % based on the amount of produced magnesium oxide.

12. The composition of claim 7, wherein the amount of the germanium oxide is in the range from 0.02 to 2 mole % based on the amount of produced magnesium oxide.

13. A method of forming a protective layer, the method comprising:
(a) uniformly mixing at least one of a magnesium oxide and a magnesium salt and at least one of a lithium salt, a lithium oxide, a germanium oxide, and a germanium element in the presence of a flux to obtain a mixture;
(b) thermally treating the mixture; and
(c) forming a deposition film using the thermally treated mixture.

14. The method of claim 13, wherein in the flux is MgF₂ or LiF.

15. The method of claim 13, wherein step (b) comprises:
calcining the mixture of step (a); and
pelletizing the calcined mixture to sinter the resultant pellets.

16. The method of claim 15, wherein the calcining is performed at about 400 to about 800° C.

17. The method of claim 15, wherein the sintering is performed at about 800 to about 1,600° C.

18. The method of claim 13, wherein step (c) is performed by chemical vapor deposition (CVD), e-beam, ion-plating, or sputtering.

19. A plasma display panel comprising:
a transparent front substrate;
a rear substrate substantially disposed in parallel to the front substrate;
barrier ribs arranged between the front substrate and the rear substrate to define discharge cells;
address electrodes extended along the discharge cells;
a phosphor layer disposed in each discharge cell;
sustain electrode pairs extending in a direction which intersects with the address electrodes;
a front dielectric layer covering the sustain electrode pairs;
a protective layer formed on a surface of the front dielectric layer; and
a discharge gas contained within the discharge cells; and
wherein the protective layer comprises at least one selected from the group consisting of a magnesium oxide and a magnesium salt and at least one selected from a group consisting of a lithium salt, a lithium oxide, a germanium oxide, and a germanium element.
